(19) United States
(12) Patent Application Publication
(10) Pub. No.: US 2019/0055933 A1
(43) Pub. Date: Feb. 21, 2019

(54) SWASH PLATE TYPE COMPRESSOR

(71) Applicants: Henry C. Chu, Orange, CA (US); Xiao Feng, Orange, CA (US)

(72) Inventors: Henry C. Chu, Orange, CA (US); Xiao Feng Li, Orange, CA (US)

(21) Appl. No.: 15/679,367

(22) Filed: Aug. 17, 2017

(51) Int. Cl. F04B 27/10; F04B 27/16; F04B 53/10; F04B 53/14; F16J 15/06

(52) U.S. Cl. CPC F04B 27/1072; F04B 27/16; F04B 53/10; F04B 27/0878; F16J 15/062; F04B 27/1045; F04B 27/1081; F04B 53/143

(57) ABSTRACT

A swash plate type compressor includes a number of cylinders engaged in a receptacle, a number of pistons slidably engaged in the cylinders and movable relative to the cylinders in a reciprocating action, a spindle rotatably engaged in the receptacle, the receptacle includes a bore for partially receiving the spindle, a spring biasing member is engaged with the spindle, a holder is engaged onto the spindle, a swash plate is attached to the holder and coupled to the pistons for moving the pistons in the reciprocating action in the cylinders, and a control valve plate device is engaged with the cylinders for guiding the air to flow from the inlet chamber of the receptacle into the cylinders and from the cylinders into the discharge chamber of the receptacle.

### BACKGROUND OF THE INVENTION

### 1. Field of the Invention

The present invention relates to a swash plate type compressor, and more particularly to a swash plate type compressor including an improved structure or configuration that may be made or manufactured with a simplified making or manufacturing procedure and with a suitably reduced manufacturing cost.

### 2. Description of the Prior Art

Typically, for vehicles and automobiles, an air conditioning system is an important facility to be provided and comprises a compressor coupled to an engine of the automobile through a rotation transmission means or belt, for allowing the compressor to be operated or actuated to generate or to provide an air conditioning by the engine of the automobile.

For example, U.S. Pat. No. 6,457,399 to Jingu, U.S. Pat. No. 6,533,555 to Yamada et al., U.S. Pat. No. 6,761,106 to Sugiura et al., U.S. Pat. No. 7,699,585 to Fukanuma et al., U.S. Pat. No. 7,862,307 to Watanabe et al., U.S. Pat. No. 9,140,249 to Hayashi et al., U.S. Pat. No. 9,328,721 to Lee et al., U.S. Pat. No. 9,441,620 to Nomura et al., U.S. Pat. No. 9,651,034 to Nakaima et al., U.S. Pat. No. 9,651,035 to Suzuki et al., and U.S. Pat. No. 9,651,036 to Yamashita et al. disclose several of the typical compressors for the air conditioning systems of the vehicles and the automobiles, and each comprising a swash plate swash plate for coupling to pistons of an engine of the automobile and for moving the pistons in a reciprocating action in the cylinders of the engine in order to generate the pressurized air.

However, the swash plate of the typical compressors may not be smoothly operated or actuated to move within the compressors in order to generate or to provide the air conditioning to the automobiles.

The present invention has arisen to mitigate and/or obviate the afore-described disadvantages of the conventional swash plate type compressors.

### SUMMARY OF THE INVENTION

The primary objective of the present invention is to provide a swash plate type compressor including an improved structure or configuration that may be made or manufactured with a simplified making or manufacturing procedure and with a suitably reduced manufacturing cost.

In accordance with one aspect of the invention, there is provided a compressor comprising a receptacle including a compartment formed in the receptacle, the receptacle including an inlet chamber and a discharge chamber formed in the receptacle and spaced from each other, an inlet manifold formed in the receptacle and communicating with the inlet chamber for introducing an air into the inlet manifold and the inlet chamber of the receptacle, a number of cylinders engaged in the compartment of the receptacle and equally spaced and arranged around the compartment of the receptacle, a number of pistons slidably received and engaged in the cylinders and movable relative to the cylinders in a reciprocating action respectively, a spindle rotatably received and engaged in the compartment of the receptacle with at least one bearing for allowing the spindle to be smoothly rotated relative to the receptacle, the receptacle including a bore formed in the receptacle and communicating with the compartment of the receptacle for partially receiving and engaging with the spindle, a spring biasing member received and engaged in the bore of the receptacle and engaged with the spindle for biasing and forcing the spindle onto the receptacle, a holder received in the compartment of the receptacle and engaged onto the spindle and rotated in concert with the spindle relative to the receptacle, a swash plate attached to the holder and coupled to the pistons for moving the pistons in the reciprocating action in the cylinders of the receptacle with the swash plate, and a control valve plate device disposed in the receptacle and engaged between the cylinders and the inlet chamber and the discharge chamber of the receptacle, the control valve plate device including an inlet check valve engaged between the cylinders and the inlet chamber of the receptacle for guiding the air to flow only from the inlet chamber of the receptacle into the cylinders and for preventing the air from flowing backward from the cylinders into the inlet chamber of the receptacle, and an outlet check valve engaged between the cylinders and the discharge chamber for limiting the air to flow only from the cylinders into the discharge chamber of the receptacle, and for preventing the air from flowing backward from the discharge chamber of the receptacle into the cylinders and for effectively pumping and generating the pressurized air.

The receptacle includes an outlet port formed in the receptacle and communicating with the discharge chamber. The pistons each include at least one aperture formed in the piston. The holder is rotatably and smoothly engaged in the compartment of the receptacle with at least one bearing. The receptacle includes at least two housing members secured together for allowing the receptacle to be easily molded and formed.

The swash plate is tilted relative to the spindle and pivotally connected to the pistons for moving the pistons in the reciprocating action in the cylinders of the receptacle. The pistons each include a cavity formed in the respective piston for partially receiving and engaging with the swash plate and for allowing the swash plate to be connected to the pistons respectively and for allowing the pistons to be effectively moved relative to the cylinders of the receptacle with the swash plate.

The pistons each include at least one gasket engaged in the cavity of each of the pistons and slidably engaged with the swash plate for pivotally connecting the swash plate to the pistons respectively. The cavities of the pistons each include a spherical shape for receiving and engaging with the gasket. The gasket includes a spherical shape.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of a compressor in accordance with the present invention;

FIG. 2 is a cross sectional view of the compressor, taken along lines 2-2 of FIG. 1;

FIG. 3 is an enlarged partial cross sectional view of the compressor;

FIG. 4 is a perspective view illustrating the swash plate holder for the compressor;

FIG. 5 is a side plan schematic view of the swash plate holder for the compressor; and

FIG. 6 is a further cross sectional view similar to FIG. 2, illustrating the other arrangement of the compressor.

### DETAILED DESCRIPTION OF THE PREFERRED EMBODIMENT

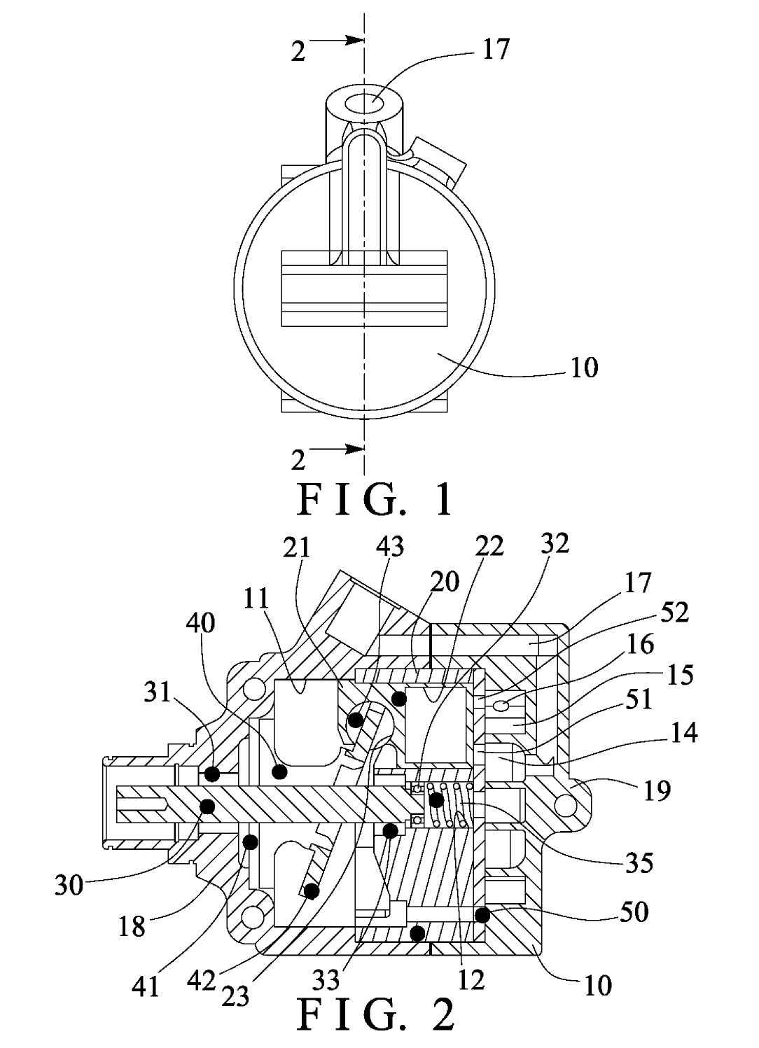

Referring to the drawings, and initially to FIGS. 1-3, a swash plate type compressor in accordance with the present invention comprises a compressor housing or receptacle 10 including a chamber or compartment 11 formed therein, a number of (such as five) housings or cylinders 20 are disposed or engaged in the compartment 11 of the receptacle 10 and equally spaced and arranged around the compartment 11 of the receptacle 10, a number of (such as five) pistons 21 are slidably received or engaged in the cylinders 20 and movable relative to the cylinders 20 in a reciprocating action, in which the pistons 21 may include one or more orifices or apertures 22 formed therein for weight reducing purposes and the like.

A shaft or spindle 30 is pivotally or rotatably received or engaged in the compartment 11 of the receptacle 10 with one or more gaskets and/or bearings 31, 32, 33 for allowing the spindle 30 to be smoothly pivoted or rotated relative to the receptacle 10. A compartment or bore 12 is formed or provided in the receptacle 10 and communicating with the compartment 11 of the receptacle 10, and disposed and arranged or located between the cylinders 20 for partially receiving or engaging with the spindle 30 and for further solidly and stably supporting the spindle 30 within the receptacle 10. A spring biasing member 35 is received or engaged in the bore 12 of the receptacle 10 and contacted or engaged with the spindle 30 for biasing and forcing or moving the spindle 30 against or onto the receptacle 10.

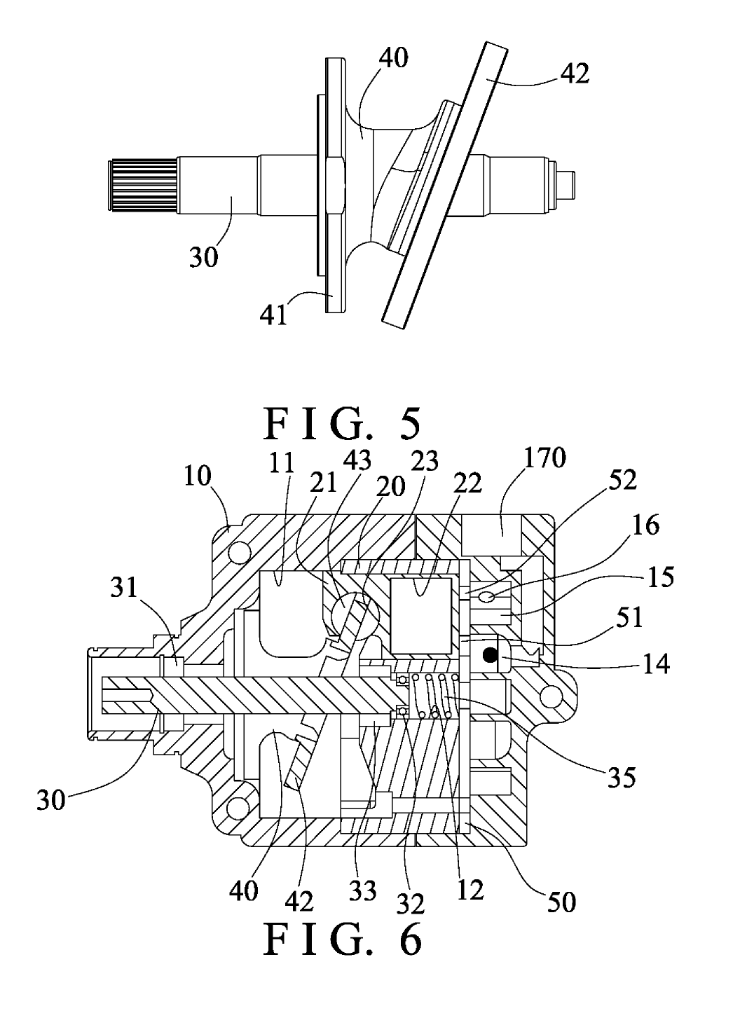

As shown in FIGS. 2-5, a swash plate carrier or holder 40 is received or engaged in the compartment 11 of the receptacle 10 and attached or engaged onto the spindle 30 and solidly and stably mounted or secured to the spindle 30 and pivoted or rotated in concert with the spindle 30 relative to the receptacle 10. The holder 40 may further be pivotally or rotatably and solidly and stably engaged in the compartment 11 of the receptacle 10 with one or more gaskets and/or bearings 41. A swash plate 42 is attached or mounted or secured to the holder 40 and substantially tilted or inclined relative to the spindle 30 and pivotally connected or coupled to the pistons 21 for moving the pistons 21 in the reciprocating action in the cylinders 20 of the receptacle 10.

The pistons 21 each may include a space or cavity 23 formed therein and having a substantially spherical shape or structure or configuration for partially receiving or engaging with the swash plate 42 and for allowing the swash plate 42 to be pivotally connected or coupled to the pistons 21 respectively, and one or more (such as two) substantially semi-spherical bearings and/or gaskets 43 are received or engaged in the cavity 23 of each of the pistons 21 and slidably engaged with the swash plate 42 for allowing the swash plate 42 to be pivotally connected or coupled to the pistons 21 respectively and for allowing the pistons 21 to be moved in the reciprocating action in the cylinders 20 of the receptacle 10 with the swash plate 42 when the swash plate 42 is pivoted or rotated relative to the receptacle 10 together with the spindle 30.

The receptacle 10 further includes an inlet chamber 14 and an outlet or discharge chamber 15 formed therein and offset or spaced or separated from each other, and an outlet port 16 also formed in the receptacle 10 and communicating with the discharge chamber 15 for gas discharging purposes. An inlet opening or manifold 17 is also formed in the receptacle 10 and communicating with the inlet chamber 14 for allowing the air to flow into the inlet manifold 17 and into the inlet chamber 14 of the receptacle 10. A control valve plate device 50 is disposed or engaged into the receptacle 10 and disposed or engaged between the cylinders 20 and the inlet chamber 14 and the discharge chamber 15 of the receptacle 10 for controlling the air to flow between the chambers 14, 15 of the receptacle 10 and the cylinders 20. As shown in FIG. 6, the inlet manifold 170 of the receptacle 10 may be formed into different shape or structure or configuration and arranged for allowing the air to easily flow into the inlet manifold 170 of the receptacle 10.

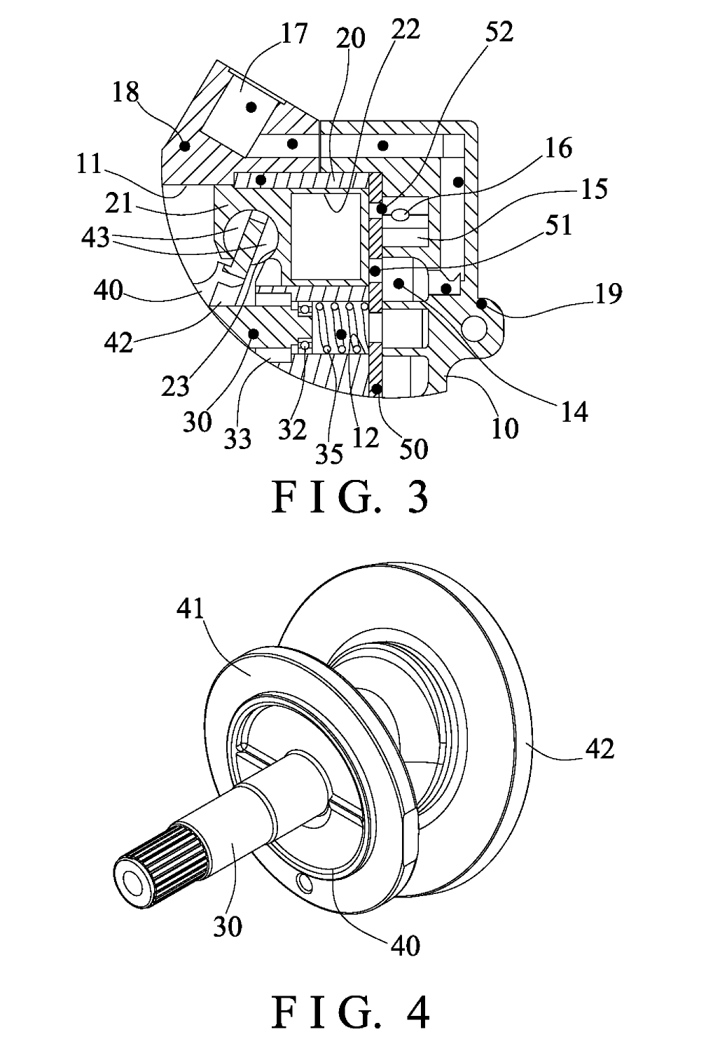

For example, the control valve plate device 50 includes an inlet check valve 51 disposed or engaged between the cylinders 20 and the inlet chamber 14 of the receptacle 10 for guiding and limiting and controlling the air to flow only from the inlet chamber 14 of the receptacle 10 into the cylinders 20, and for preventing the air from flowing backward from the cylinders 20 into the inlet chamber 14 of the receptacle 10, and an outlet check valve 52 disposed or engaged between the cylinders 20 and the discharge chamber 15 for guiding and limiting and controlling the air to flow only from the cylinders 20 into the discharge chamber 15 of the receptacle 10, and for preventing the air from flowing backward from the discharge chamber 15 of the receptacle 10 into the cylinders 20. As shown in FIGS. 2-3, the receptacle 10 may include one or more (such as two) housing members 18, 19 secured together.

In operation, as shown in FIG. 2, the pistons 21 may be moved in the reciprocating action in the cylinders 20 of the receptacle 10 with the swash plate 42 when the swash plate 42 is pivoted or rotated relative to the receptacle 10 together with the spindle 30. The movement of the pistons 21 away from the control valve plate device 50 may introduce the air into the cylinders 20, and may force the air to flow out of the cylinders 20 when the pistons 21 are moved toward the control valve plate device 50.

Accordingly, the swash plate type compressor in accordance with the present invention includes an improved structure or configuration that may be made or manufactured with a simplified making or manufacturing procedure and with a suitably reduced manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A compressor comprising:
a receptacle including a compartment formed in said receptacle, said receptacle including an inlet chamber and a discharge chamber formed in said receptacle and spaced from each other, an inlet manifold formed in said receptacle and communicating with said inlet chamber for introducing an air into said inlet manifold and said inlet chamber of said receptacle;
a plurality of cylinders engaged in said compartment of said receptacle and equally spaced and arranged around said compartment of said receptacle;
a plurality of pistons slidably received and engaged in said cylinders and movable relative to said cylinders in a reciprocating action respectively;
a spindle rotatably received and engaged in said compartment of said receptacle with at least one bearing for allowing said spindle to be smoothly rotated relative to said receptacle, said receptacle including a bore formed in said receptacle and communicating with said compartment of said receptacle for partially receiving and engaging with said spindle;
a spring biasing member received and engaged in said bore of said receptacle and engaged with said spindle for biasing and forcing said spindle onto said receptacle;
a holder received in said compartment of said receptacle and engaged onto said spindle and rotated in concert with said spindle relative to said receptacle;
a swash plate attached to said holder and coupled to said pistons for moving said pistons in the reciprocating action in said cylinders of said receptacle with said swash plate; and
a control valve plate device disposed in said receptacle and engaged between said cylinders and said inlet chamber and said discharge chamber of said receptacle, said control valve plate device including an inlet check valve engaged between said cylinders and said inlet chamber of said receptacle for guiding the air to flow only from said inlet chamber of said receptacle into said cylinders and for preventing the air from flowing backward from said cylinders into said inlet chamber of said receptacle, and an outlet check valve engaged between said cylinders and said discharge chamber for limiting the air to flow only from said cylinders into said discharge chamber of said receptacle, and for preventing the air from flowing backward from said discharge chamber of said receptacle into said cylinders.

2. The compressor as claimed in claim 1, wherein said receptacle includes an outlet port formed in said receptacle and communicating with said discharge chamber.

3. The compressor as claimed in claim 1, wherein said pistons each include at least one aperture formed in said piston.

4. The compressor as claimed in claim 1, wherein said holder is rotatably engaged in said compartment of said receptacle with at least one bearing.

5. The compressor as claimed in claim 1, wherein said swash plate is tilted relative to said spindle and pivotally connected to said pistons.

6. The compressor as claimed in claim 5, wherein said pistons each include a cavity formed in said respective piston for partially receiving and engaging with said swash plate and for allowing said swash plate to be connected to said pistons respectively.

7. The compressor as claimed in claim 6, wherein said pistons each include at least one gasket engaged in said cavity of each of said pistons and slidably engaged with said swash plate for pivotally connecting said swash plate to said pistons respectively.

8. The compressor as claimed in claim 6, wherein said cavities of said pistons each include a spherical shape for receiving and engaging with said at least one gasket.

9. The compressor as claimed in claim 8, wherein said at least one gasket includes a spherical shape.

10. The compressor as claimed in claim 1, wherein said receptacle includes at least two housing members secured together.
